(19) United States
(12) Patent Application Publication
(10) Pub. No.: US 2006/0236084 A1
(43) Pub. Date: Oct. 19, 2006

(54) METHOD AND SYSTEM FOR PROVIDING AN AUXILIARY BIOS CODE IN AN AUXILIARY BIOS MEMORY UTILIZING TIME EXPIRY CONTROL

(76) Inventors: Dune-Ren Wu, Hsinchu (TW); Tseng-Wen Chen, Hsinchu (TW)

Correspondence Address: NORTH AMERICA INTELLECTUAL PROPERTY CORPORATION, P.O. BOX 506, MERRIFIELD, VA, 22116, US

(21) Appl. No.: 10/907,778

(22) Filed: Apr. 15, 2005

(51) Int. Cl. G06F 15/177

(52) U.S. Cl. 713/2

(57) ABSTRACT

The present invention provides a method for providing an auxiliary basic input/output system (BIOS) code in a computer system, where the computer system includes a central processing unit (CPU) for executing an operation system (OS) program. The method comprises: providing a main BIOS memory for storing a main BIOS code to be executed in a main mode; providing an auxiliary BIOS memory for storing the auxiliary BIOS code to be executed in an auxiliary mode; and in the main mode, if a specific time interval expires and the OS program is not successfully executed, disabling the main BIOS code, enabling the auxiliary BIOS code, and resetting the computer system to switch from the main mode to the auxiliary mode.

### BACKGROUND OF INVENTION

1. Field of the Invention

The present invention relates to basic input/output system (BIOS) recovery, and more particularly, to a method and a system for providing an auxiliary BIOS code in an auxiliary BIOS memory utilizing time expiry control.

2. Description of the Prior Art

A basic input/output system (BIOS) is essential for a computer system such as a personal computer (PC). Damage to a BIOS code stored in a BIOS memory, which is a non-volatile memory such as a FLASH memory, typically leads to malfunction of the PC.

A method for solving this problem is providing a main BIOS code and an auxiliary BIOS code, where both of main and auxiliary BIOS codes are stored in the same BIOS memory. According to this method, if a memory mapping error of the main BIOS code occurs, the auxiliary BIOS code will be executed. Another method for solving the same problem is providing a main BIOS code stored in a main BIOS memory and an auxiliary BIOS code stored in an auxiliary BIOS memory, where the main and auxiliary BIOS memories are connected to the same interface and have the same storage volume. For example, if the storage volume of the main BIOS memory is 2M bits, the storage volume of the auxiliary BIOS memory is also 2M bits. According to this method, if there exists a difference between a specific value read from the main BIOS memory and a corresponding value read from the auxiliary BIOS memory, the auxiliary BIOS code will be executed. Both of the methods mentioned above require double the storage volume of BIOS memory resources in contrast to the architecture with single BIOS code.

### SUMMARY OF INVENTION

It is an objective of the claimed invention to provide a method and a system for providing an auxiliary basic input/output system (BIOS) code in an auxiliary BIOS memory utilizing time expiry control.

A method for providing an auxiliary BIOS code in a computer system is disclosed, where the computer system includes a central processing unit (CPU) for executing an operation system (OS) program. According to one embodiment of the claimed invention, the method comprises: providing a main BIOS memory for storing a main BIOS code to be executed in a main mode; providing an auxiliary BIOS memory for storing the auxiliary BIOS code to be executed in an auxiliary mode; and in the main mode, if a specific time interval expires and the OS program is not successfully executed, disabling the main BIOS code, enabling the auxiliary BIOS code, and resetting the computer system to switch from the main mode to the auxiliary mode.

A computer system is further disclosed. According to one embodiment of the claimed invention, the computer system comprises: a CPU for executing an OS program; a main BIOS memory coupled to the CPU for storing a main BIOS code to be executed in a main mode; a control circuit coupled to the CPU for time expiry control; and an auxiliary BIOS memory coupled to the control circuit for storing an auxiliary BIOS code to be executed in an auxiliary mode. In the main mode, if a specific time interval expires and the OS program is not successfully executed, the control circuit disables the main BIOS code, enables the auxiliary BIOS code, and resets the computer system to switch from the main mode to the auxiliary mode.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a computer system according to one embodiment of the present invention.

FIG. 2 is a flowchart of the control circuit shown in FIG. 1.

FIG. 3 illustrates steps for replacing Step 952 shown in FIG. 2 according to a variation of the embodiment.

### DETAILED DESCRIPTION

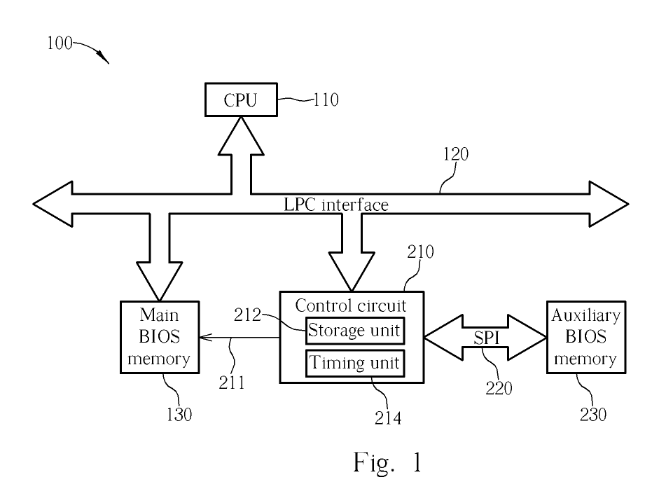

Please refer to FIG. 1. FIG. 1 is a diagram of a computer system 100 according to a first embodiment of the present invention. The computer system 100 comprises a central processing unit (CPU) 110 for executing an operation system (OS) program. Typically, the computer system 100 further comprises control chipsets (not shown), e.g., a North Bridge chipset and a South Bridge chipset, for maintaining operations of a motherboard where the CPU 110, the North Bridge chipset, and the South Bridge chipset are positioned. In addition, the computer system 100 typically comprises storage devices (not shown) such as random access memories (RAMs) and hard disks (HDs). Operations and principles of the CPU 110, the OS program, the North Bridge chipset, the South Bridge chipset, the RAMs and the HDs mentioned above and connections between these components are well known in the art and therefore not explained in detail here.

As provided in this embodiment, the computer system 100 further comprises a main basic input/output system (BIOS) memory 130, a control circuit 210, and an auxiliary BIOS memory 230, where the main BIOS memory 130 and the control circuit 210 are coupled to the CPU 110 through a low pin count (LPC) interface 120, and the auxiliary BIOS memory 230 is coupled to the control circuit 210 through a serial peripheral interface (SPI) 220. According to this embodiment, the main BIOS memory 130 and the auxiliary BIOS memory 230 are non-volatile memories, and more particularly, FLASH memories. The main BIOS memory 130 is utilized for storing a main BIOS code to be executed in a main mode, which is a normal mode for normal operations of the computer system 100 in this embodiment. In addition, the auxiliary BIOS memory 230 is utilized for storing an auxiliary BIOS code to be executed in an auxiliary mode. In this embodiment, if the main BIOS code is considered damaged, the computer system 100 switches from the main mode to the auxiliary mode.

As shown in FIG. 1, the control circuit 210 is capable of asserting/de-asserting a FLASH enable signal 211 to enable/disable the main BIOS code. That is, the control circuit 210 enables the main BIOS memory 130 and the main BIOS code therein by asserting the FLASH enable signal 211, and disables the main BIOS memory 130 and the main BIOS code therein by de-asserting the FLASH enable signal 211. Similarly, the control circuit 210 is also capable of asserting/de-asserting another FLASH enable signal 211A (not shown) to enable/disable the auxiliary BIOS code. That is, through the SPI 220, the control circuit 210 enables the auxiliary BIOS memory 230 and the auxiliary BIOS code therein by asserting the FLASH enable signal 211A, and disables the auxiliary BIOS memory 230 and the auxiliary BIOS code therein by de-asserting the FLASH enable signal 211A.

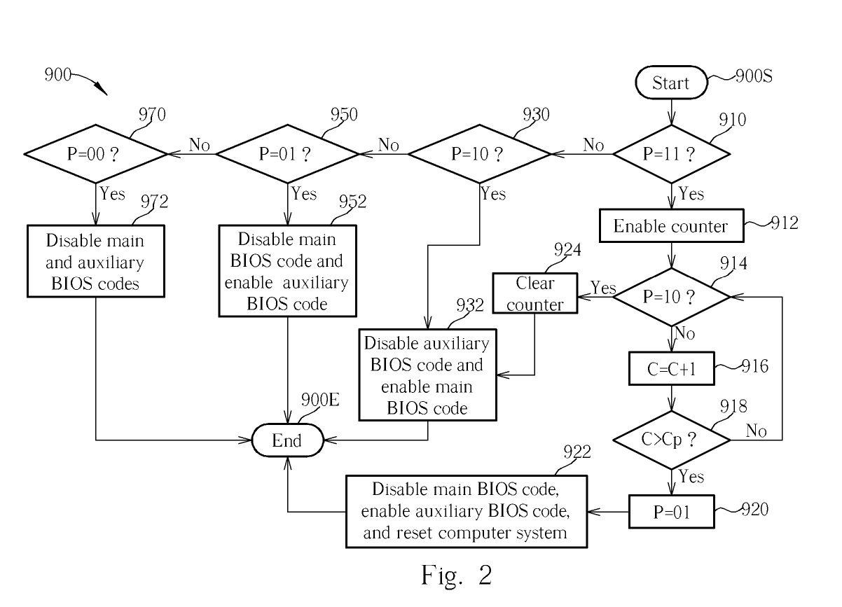

In this embodiment, the control circuit 210 further comprises a storage unit 212, where the control circuit 210 utilizes the storage unit 212 to store a parameter that typically represents an operation mode such as the main mode or the auxiliary mode mentioned above. Please refer to FIG. 1 and FIG. 2. FIG. 2 illustrates a flowchart 900 of the control circuit 210 shown in FIG. 1, where Steps 910, 912, 914, . . . , and 922 together with Steps 924 and 932 can be executed in the main mode, and Steps 910, 930, 950, and 952 can be executed in the auxiliary mode. According to this embodiment, the storage unit 212 is a register, and the parameter therein, i.e., the parameter P shown in FIG. 2, comprises two bits respectively represent enabling/disabling states of the main and auxiliary BIOS codes. As shown in FIG. 2, Steps 910, 930, 950, and 970 respectively have checking operations of the parameter P, where the order of checking if the parameter P is equal to 00, 01, 10, and 11 can be varied according to another embodiment of the present invention. Please note that an initial value of the parameter P can be set to be 11, so if the main BIOS code is considered damaged, the computer system 100 may switch from the main mode to the auxiliary mode.

In addition, the control circuit 210 is also utilized for time expiry control. As shown in FIG. 1, the control circuit 210 further comprises a timing unit 214, where the control circuit 210 further utilizes the timing unit 214 to time a specific time interval. According to this embodiment, the timing unit 214 is a counter coupled to a reference clock source (not shown) such as an oscillator or an external frequency generator, and the specific time interval corresponds to a predetermined threshold value Cp to be compared with a counter value C of the counter. Please note that a timer known in the art can be utilized as the timing unit 214 according to other embodiments of the present invention. In addition, a delay unit (e.g. a digital delay circuit or an R-C circuit) may generate time information corresponding to the specific time interval, so the delay unit can be utilized as the timing unit 214 according to other embodiments of the present invention.

In Step 910, if the parameter P is equal to 11, Step 912 is then executed. In Step 912, the control circuit 210 enables the timing unit 214, i.e., the counter in this embodiment. An initial value of the counter value C is set to be 0. A loop comprising Steps 914, 916, and 918 is executed repeatedly until the parameter P is changed by the OS program or an application program executed in the environment provided by the OS program. Please note that if the OS program is successfully executed, the main BIOS code is not considered damaged. After the OS program or the application program mentioned above changes the parameter P to be 10, the loop is broken by executing Step 924, so the control circuit 210 clears the counter, i.e., the counter value C is changed to be 0.

On the other hand, every time when Step 916 is executed, the counter value C is changed with an increment of one. As time goes by, the counter value C approaches the predetermined threshold value Cp gradually. In Step 918, if the counter value C is less than or equal to the predetermined threshold value Cp, Step 914 is then executed. However, in Step 918, if the counter value C is greater than the predetermined threshold value Cp, i.e., the specific time interval expires, Step 920 is executed and the parameter P is set to be 01 by the control circuit 210. Please note, the expiry of the specific time interval represents that the OS program is not successfully executed, so the main BIOS codes is considered damaged. Therefore, in Step 922, the control circuit 210 disables the main BIOS code, enables the auxiliary BIOS code, and resets the computer system 100 by sending out a reset signal RST (not shown) through the LPC interface 120 to switch from the main mode to the auxiliary mode.

In the auxiliary mode according to this embodiment, Steps 910, 930, and 950 are executed since in the main mode, the control circuit 210 set the parameter P to be 01 (in Step 920). After Step 950, Step 952 is entered and the control circuit 210 disables the main BIOS code and enables the auxiliary BIOS code. As a result, the auxiliary BIOS code is executed as a backup of the main BIOS code. It is unnecessary that the auxiliary BIOS memory 230 has the same storage volume as that of the main BIOS memory 130 since the auxiliary BIOS memory 230 is coupled to the CPU 110 through the control circuit 210 rather than direct coupling through the LPC interface 120. The storage volume of the auxiliary BIOS memory 230 and costs thereof can be reduced correspondingly in contrast to the prior art.

It is noted that by setting the value of the parameter P to be 00, both of the main and auxiliary BIOS codes can be disabled as needed. In this situation, after the checking operations of the parameter P in Steps 910, 930, 950, and 970 are executed, Step 972 is then entered, so both of the main and auxiliary BIOS codes are disabled.

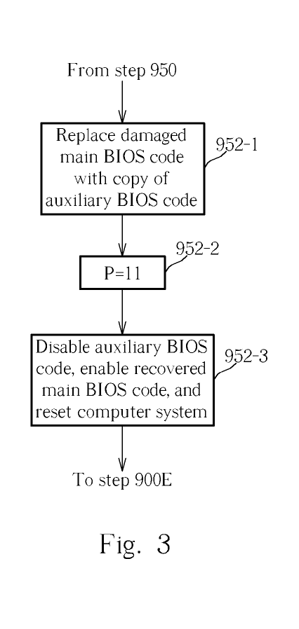

A variation of the first embodiment is similar to the first embodiment but the computer system 100 according to this variation further has BIOS auto-recovery functionality in the auxiliary mode. In this variation, Step 952 shown in FIG. 2 is replaced with Steps 952-1, 952-2, and 952-3 shown in FIG. 3. In Step 952-1, the damaged main BIOS code in the main BIOS memory 130 is replaced with a copy of the auxiliary BIOS code in the auxiliary BIOS memory 230, in order to recover the main BIOS code. In Step 952-2, the parameter P is set to be 11 by the control circuit 210. In Step 952-3, the control circuit 210 disables the auxiliary BIOS code, enables the recovered main BIOS code, and resets the computer system 100 by sending out the reset signal RST through the LPC interface 120 again to switch from the auxiliary mode to the main mode.

A second embodiment of the present invention is similar to the first embodiment but the LPC interface 120 is replaced with a firmware hub (FWH) interface in the second embodiment.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A computer system, comprising:
a central processing unit (CPU) for executing an operation system (OS) program;
a main basic input/output system (BIOS) memory coupled to the CPU for storing a main BIOS code to be executed in a main mode;
a control circuit coupled to the CPU for time expiry control; and
an auxiliary BIOS memory coupled to the control circuit for storing an auxiliary BIOS code to be executed in an auxiliary mode;
wherein in the main mode, if a specific time interval expires and the OS program is not successfully executed, the control circuit disables the main BIOS code, enables the auxiliary BIOS code, and resets the computer system to switch from the main mode to the auxiliary mode.

2. The computer system of claim 1, wherein the auxiliary BIOS code is utilized for recovering the main BIOS code, and in the auxiliary mode, the control circuit is capable of disabling the auxiliary BIOS code, enabling the recovered main BIOS code, and resetting the computer system to switch from the auxiliary mode to the main mode.

3. The computer system of claim 1, wherein the control circuit further comprises:
a storage unit for storing a parameter;
wherein the control circuit is capable of setting a value of the parameter to enable/disable the main BIOS code or the auxiliary BIOS code.

4. The computer system of claim 3, wherein the storage unit is a register.

5. The computer system of claim 1, wherein the control circuit further comprises:
a timing unit for timing the specific time interval.

6. The computer system of claim 5, wherein the timing unit is a timer, a counter, or a delay unit.

7. The computer system of claim 1, wherein the main BIOS memory and the control circuit are coupled to the CPU through a first interface, and the auxiliary BIOS memory is coupled to the control circuit through a second interface.

8. The computer system of claim 7, wherein the first interface is a low pin count (LPC) interface or a firmware hub (FWH) interface, and the second interface is a serial peripheral interface (SPI).

9. The computer system of claim 1, wherein the main and auxiliary BIOS memories are non-volatile memories.

10. The computer system of claim 9, wherein the main and auxiliary BIOS memories are FLASH memories, and the control circuit is capable of asserting/de-asserting a FLASH enable signal to enable/disable the main BIOS code.

11. A method for providing an auxiliary basic input/output system (BIOS) code in a computer system, the computer system including a central processing unit (CPU) for executing an operation system (OS) program, the method comprising:
providing a main BIOS memory for storing a main BIOS code to be executed in a main mode;
providing an auxiliary BIOS memory for storing the auxiliary BIOS code to be executed in an auxiliary mode; and
in the main mode, if a specific time interval expires and the OS program is not successfully executed, disabling the main BIOS code, enabling the auxiliary BIOS code, and resetting the computer system to switch from the main mode to the auxiliary mode.

12. The method of claim 11, wherein the auxiliary BIOS code is utilized for recovering the main BIOS code, and the method further comprises:
in the auxiliary mode, disabling the auxiliary BIOS code, enabling the recovered main BIOS code, and resetting the computer system to switch from the auxiliary mode to the main mode.

13. The method of claim 11, further comprising:
storing a parameter; and
setting a value of the parameter to enable/disable the main BIOS code or the auxiliary BIOS code.

14. The method of claim 13, further comprising:
utilizing a register for storing the parameter.

15. The method of claim 11, further comprising:
timing the specific time interval.

16. The method of claim 15, further comprising:
utilizing a timer, a counter, or a delay unit for timing the specific time interval.

17. The method of claim 11, further comprising:
coupling the main BIOS memory to the CPU through a first interface;
providing a control circuit coupled to the CPU through the first interface, wherein the control circuit is utilized for time expiry control; and
coupling the auxiliary BIOS memory to the control circuit through a second interface.

18. The method of claim 17, further comprising:
utilizing a low pin count (LPC) interface or a firmware hub (FWH) interface as the first interface; and
utilizing a serial peripheral interface (SPI) as the second interface.

19. The method of claim 11, wherein the main and auxiliary BIOS memories are non-volatile memories.

20. The method of claim 19, wherein the main and auxiliary BIOS memories are FLASH memories, and the method further comprises:
asserting/de-asserting a FLASH enable signal to enable/disable the main BIOS code.
